(19) United States
(12) Patent Application Publication
(10) Pub. No.: US 2025/0073729 A1
(43) Pub. Date: Mar. 6, 2025

(54) Device and Method for Spraying a Multicomponent Plastic Material

(71) Applicant: Henkel AG & Co. KGaA, Duesseldorf (DE)

(72) Inventors: Priya Subramanian, Victoria (AU); Jody Martens, Darlington (AU); Graeme McDonald, Victoria (AU)

(21) Appl. No.: 18/949,103

(22) Filed: Nov. 15, 2024

Related U.S. Application Data
(63) Continuation of application No. PCT/EP2023/062975, filed on May 15, 2023.

(30) Foreign Application Priority Data
May 23, 2022 (EP) 22174817.1

(51) Int. Cl. B05B 7/04; B05B 7/12

(52) U.S. Cl. CPC B05B 7/0408; B05B 7/12

(57) ABSTRACT

The invention relates to a device for applying a multicomponent plastic to a substrate and a method of using same, the device comprising: a dosing valve which can be controlled by compressed air as pressure medium and has a first valve inlet for a first component, a second valve inlet for a second component and a valve outlet; a static spray mixer comprising a tubular mixer housing extending along a longitudinal axis and having a valve-side end and a distal end, a mixing element disposed within the mixer housing for producing a component mixture, and an atomization sleeve disposed on the distal end of the mixer housing and having an inlet for a pressurized atomizing medium wherein the mixer housing and the mixing element are made of plastic and the mixing element is a one-piece component that is inserted into the mixer housing.

The invention relates to a device for spraying a multicomponent plastic onto a substrate and to a method using this device.

From U.S. Pat. No. 5,255,892 a dosing valve is known which has a first valve inlet for a first component and a second valve inlet for a second component. A needle is assigned to each valve inlet wherein through the needle a passage to a valve outlet can be opened or closed. The needle is connected to a control piston, which is part of a cylinder unit of the dosing valve and can be pressurized with compressed air. The dosing valve can also be used to dispense highly viscous plastic components. The dosing valve is preferably part of a system with which the multicomponent plastic can be sprayed onto the substrate in large quantities over a long period of time.

A static spray mixer can be connected to the valve outlet of the dosing valve, the mixer having a tubular mixer housing extending along a longitudinal axis. The mixer housing has a valve-side end connectable to the valve outlet and a distal end provided with an outlet nozzle. A mixing element is arranged in the mixer housing to mix as homogeneously as possible the first component and the second component, which separately leave the valve outlet of the dosing valve. The two components are thereby passed through the mixing element from the valve-side end to the distal end along the longitudinal axis, so that a homogeneous mixture of the first component and the second component is produced in the mixer housing. An atomization sleeve is disposed on the distal end of the mixer housing. The atomization sleeve has an inlet for a pressurized atomizing medium. This atomizing medium can be compressed air, for example. The atomization makes it possible to apply the mixture of the two components emerging from the outlet nozzle to the substrate in the form of a spray jet or spray mist, in order to achieve the most uniform and continuous application of the multicomponent plastic possible.

The desired goal of a uniform application with a constant layer thickness depends on many factors. For example, with some components or with a viscous mixture of the two components, satisfactory results are only achieved if at least one of the two components is heated beforehand, but this makes the application of the multicomponent plastic laborious. Although the pressure at which the two components leave the dosing valve and also the pressure of the atomizing medium can be varied over a wide range, varying the pressures does not necessarily lead to the desired result.

### SUMMARY OF THE INVENTION

The invention is based on the object of providing a device for spraying a multicomponent plastic, by means of which a viscous multicomponent plastic can also be easily and homogeneously sprayed onto a substrate.

The object underlying the invention is solved with the combination of features according to claim 1. Examples of embodiments of the invention can be taken from the subclaims to claim 1.

In one embodiment, the invention relates to a device 1 for applying a multicomponent plastic to a substrate, comprising
a dosing valve 10 which can be controlled by compressed air as pressure medium and has a first valve inlet 11 for a first component 2, a second valve inlet 12 for a second component 3 and a valve outlet 17,
a static spray mixer 50 comprising a tubular mixer housing 53 extending along a longitudinal axis and having a valve-side end 54 and a distal end 55, a mixing element 57 disposed within the mixer housing 53 for producing a component mixture, and an atomization sleeve 51 disposed on the distal end 55 of the mixer housing 53 and having an inlet 52 for a pressurized atomizing medium.

The invention is characterized in that the mixer housing 53 and the mixing element 57 are made of plastic and that the mixing element 57 is a one-piece component that is inserted into the mixer housing 53. Furthermore, the invention relates to a method in which the device 1 is used.

According to the invention, it is provided that the mixer housing and the mixing element are made of plastic and that the mixing element is a one-piece element that is inserted into the mixer housing. The mixing element may be an injection-molded part which, on the one hand, enables good mixing of highly viscous substances such as sealants, two-component foams or two-component adhesives due to an efficient mixing structure and, on the other hand, enables a compact and material-saving design of the static spray mixer. It has been found that the combination of such spray mixers, which are usually designed for single use, in conjunction with the dosing valve or with the system, which is suitable for spraying larger quantities over a longer period of time, leads to good results in terms of homogeneity and layer thickness of the plastic layer. It has further been found that the lifetime of the plastic spray mixer with the plastic mixing element used is sufficiently good. Static mixers with a one-piece mixing element made of plastic are known, for example, from the documents EP 0 749 776 and EP 0 815 929.

In one embodiment, a cross-section of the mixer housing perpendicular to the longitudinal axis and a cross-section of the mixer element perpendicular to the longitudinal axis are each rectangular, preferably square. The cross-section of the mixer housing need not be rectangular or square along the entire length of the mixer housing, but only in the section in which the mixer element is accommodated. For example, the mixer housing may have a rectangular or square cross-section in a middle section, while the valve-side end and the distal end are substantially rotationally symmetrical. Such spray mixers are sold, for example, by the Sulzer group.

In one embodiment, the atomization sleeve can be fitted onto the distal end along the longitudinal axis of the mixer housing. A snap connection can be provided between the atomization sleeve and the mixer housing. The snap connection ensures that in the axial direction the atomization sleeve is fixed on the distal end. In addition, the snap connection can also have a sealing effect so that compressed air supplied through the inlet of the atomization sleeve cannot escape unintentionally. In addition to the snap connection, a separate seal may be provided. It should be noted that in principle there are also other ways of fastening the atomization sleeve to the distal end for example, screw connection or bayonet lock.

A separate adapter can be provided between the valve outlet and the valve-side end of the spray mixer for detachably attaching the spray mixer to the dosing valve. This makes it possible to replace the spray mixer with, for example, a new spray mixer. This replacement is possible in a simple manner if the atomization sleeve can also be easily pulled from the distal end of the mixer housing.

The adapter may include an adapter housing, valve connection means for releasable attachment to the dosing valve, and mixer connection means for releasable attachment of the spray mixer to the adapter. Thus, in addition to simply replacing the spray mixer, it is also possible to disconnect the adapter from the dosing valve, for example, to connect a different type of spray mixer to the dosing valve. The valve connection means and/or the mixer connection means may be integrally formed to the adapter housing. In one embodiment, the valve connection means and the adapter housing are separate parts. The adapter housing is preferably made of metal. Preferred materials here are stainless steel for instance 304 SS or aluminum.

The adapter housing can have a recess to accommodate a divider of the dosing valve. The divider is part of the valve outlet of the metering system and ensures that the components leaving the dosing valve first meet in the spray mixer and yet are mixed.

In one embodiment, the adapter housing defines a rectilinear channel for the first component and a rectilinear channel for the second component. Thus, the components can pass through the adapter housing without deflection and the associated flow resistance.

A further object of the invention comprises a method for spraying a multicomponent plastic onto the substrate by using a device as disclosed herein, in particular a device comprising: a dosing valve which can be controlled by compressed air as pressure medium and has a first valve inlet for a first component, a second valve inlet for a second component and a valve outlet; a static spray mixer comprising a tubular mixer housing extending along a longitudinal axis and having a valve-side end and a distal end, a mixing element disposed within the mixer housing for producing a component mixture, and an atomization sleeve disposed on the distal end of the mixer housing and having an inlet for a pressurized atomizing medium; wherein the mixer housing and the mixing element are made of plastic and that the mixing element is a one-piece component that is inserted into the mixer housing.

The multicomponent plastic is preferably polyurea, which may be solvent-free and free of volatile organic components VOC. Such a polyurea is marketed, for example, as a two-component adhesive under the trademark LINA 888. With the LINA 888 polyurea, it is not necessary to heat one or both components and/or the substrate. The curing of LINA 888 is almost independent of weather conditions and results in reproducible and reliable bond strengths. In one embodiment, the components are mixed together in a ratio of 2:1.

### BRIEF DESCRIPTION OF THE DRAWINGS

The invention is explained in more detail with reference to the embodiments shown in the drawings:

FIG. 1 shows a schematic view of the structure of a device according to the invention;

FIG. 2 shows a perspective view of an adapter for the device according to the invention;

FIGS. 3A, 3B, 3C and 3D show different views of the adapter of FIG. 2:

FIG. 3A shows a side view of the adapter 30 shown in FIG. 2;

FIG. 3B shows a top view of the adapter 30 shown in FIG. 2;

FIG. 3C shows a bottom view of the adapter 30 of FIG. 2.

FIG. 3D is a sectional view of the adapter 30 along the line 3D-3D shown in FIG. 3A.

FIG. 4 shows a perspective view of a dosing valve for the device according to the invention;

FIG. 5 shows a spray mixer for the device according to the invention.

### DETAILED DESCRIPTION OF EMBODIMENTS OF THE INVENTION

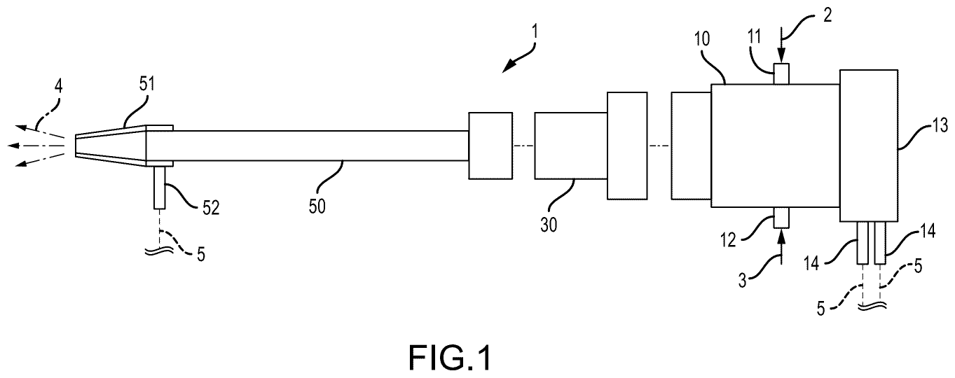

FIG. 1 schematically shows a device for spraying a multicomponent plastic, which is designated in its entirety as 1. The device 1 comprises a dosing valve 10, an adapter 30 and a spray mixer 50, which are shown in an unassembled state for the sake of clarity. The device 1 is used to mix a first component 2 and a second component 3 to form the multicomponent plastic and to apply it in the form of a spray 4 to a substrate not shown here. The substrate may be, for example, a flat metal sheet. The multicomponent plastic can be a polyurea adhesive, for example.

The dosing valve 10 has a first valve inlet 11 for the first component 2 and a second valve inlet 12 for the second component 3. Compressed air 5 is used to control the dosing valve 10 and is fed into a cylinder unit 13 of the dosing valve 10. The compressed air 5 can be used to control the flow of the first component 2 and the flow of the second component 3 through the dosing valve 10. In FIG. 1, two ports 14 of the cylinder unit 13 are shown as an example for a plurality of ports through which compressed air can enter or leave the cylinder unit.

Starting from the dosing valve 10, the first component 2 and the second component 3 are fed through the adapter 30 to the spray mixer 50. Components 2, 3 are guided in separate paths in the dosing valve 10 and in the adapter 30. Only in the spray mixer 50 the components 2, 3 are brought together and intensively mixed there. To produce the spray yet 4, the mixer 50 has an atomization sleeve 51 with an inlet 52 for compressed air 5. A supply of compressed air 5 for the atomization sleeve 51 or a control unit for compressed air 5 for the dosing valve 10 are not shown further in FIG. 1.

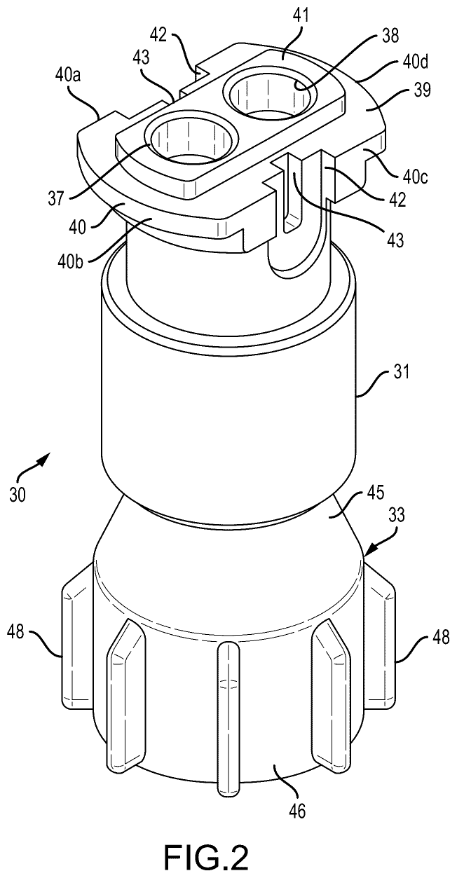

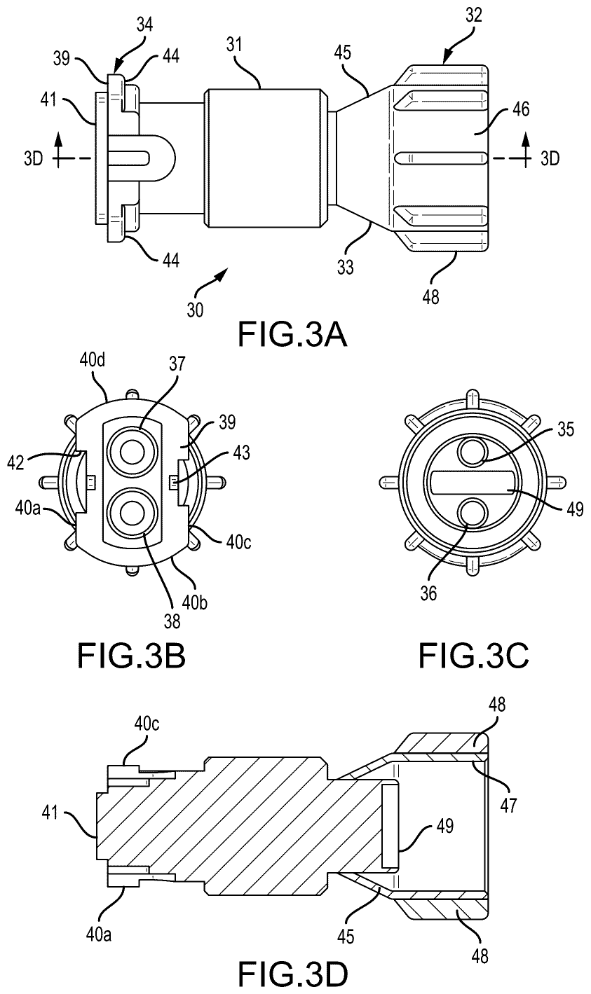

FIGS. 2 and 3 show an embodiment of the adapter 30. FIG. 3A shows a side view of the adapter 30. FIG. 3D is a sectional view along the line d-d in FIG. 3A. FIG. 3B shows the adapter 30 from the front and thus shows the side facing the spray mixer 50. FIG. 3C shows the adapter 30 from the rear.

The adapter 30 has an adapter housing 31, valve connection means 32 in the form of a swivel nut 33, and mixer connection means 34. The adapter 30 can be connected to the dosing valve 10 by means of the valve connection means 32. The mixer connection means 3 are used to connect the spray mixer 50 to the adapter 30.

The adapter 30 has a first adapter inlet 35 for the first component 2 and a second adapter inlet 36 for the second component 3. A groove-shaped deepening 49 is provided between the adapter inlets 36, 37. Within the adapter housing 31, a first rectilinear channel extends from the first adapter inlet 35 to a first adapter outlet 37 and a second rectilinear channel extends from the second adapter inlet 36 to a second adapter outlet 38.

The mixer connection means 34 includes an end plate 39 with a raised portion 41 in which the adapter outlets 37, 38 are located. The end plate 39 is bounded by a rim 40 having four rim sections 40a, 40b, 40c and 40d. The rim sections 40a and 40c are parallel to each other and extend in a straight line. A pocket 42 of rectangular cross-section is formed in each of the rim sections 40a, 40b. Each pocket 42 also has a small recess 43 at the bottom of the pocket. The rim sections 40b and 40d represent circular segments of a circle, the center of which lies on the center axis of the adapter 30 the center axis of the adapter 30 also represents the center axis of the swivel nut 33. The circle segments or the circular rim sections 40b, 40d each extend in an angular range of approximately 90°. The rectilinear rim sections 40a, 40c can also be viewed as flattenings of a circular cover plate.

The circular rim portions 40b, 40d each form a rear or trailing edge 44 which can be engaged behind by a rotatable bayonet lock cover not shown in the figures seated on the spray mixer. The mixer connection means may thus also be referred to as part of a bayonet connection.

The swivel nut 33 has a conical segment 45 and a cylindrical segment 46, on the inside of which an internal thread 47 and on the outside of which gripping ribs 48 are provided. The grip ribs 48, which are parallel to one another, run in the axial direction and are evenly distributed around the circumference. With the aid of the grip ribs 48, the swivel nut 33 can be screwed onto a corresponding external thread by hand with sufficient force. While the adapter housing 31 and the end plate 39 are preferably manufactured in one piece from metal, the swivel nut can be a separate injection-molded part made of plastic.

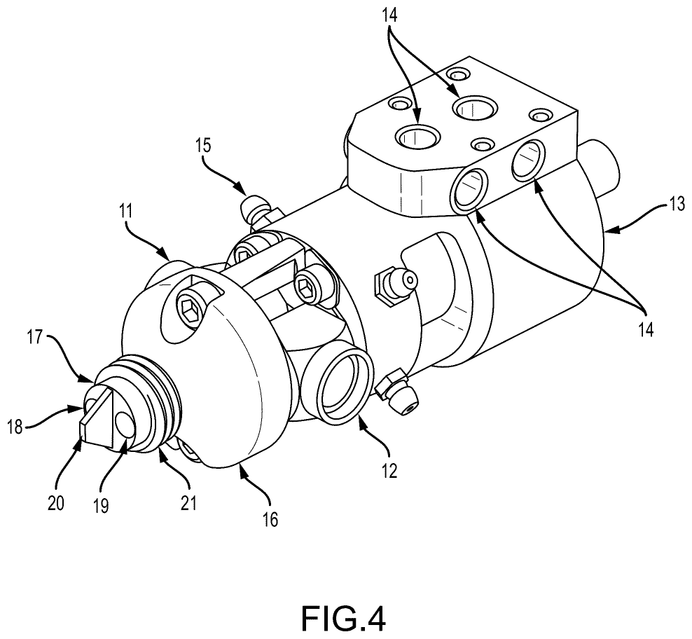

FIG. 4 shows an example of the dosing valve 10. The cylinder unit 13 of FIG. 4 has four ports 14 for compressed air, with which the dosing valve 10 can be controlled. Lubrication nipples 15 are provided between the valve inlets 11, 12 and the cylinder unit 13, through which lubrication of the control pistons displaceably mounted in the housing of the dosing valve 10 is possible. A funnel-shaped mouthpiece 16 forms a valve outlet 17 which provides an opening 18, 19 for each component 2, 3. A trapezoidal divider 20 is provided between the openings 18, 19. The divider 20 engages in the recess 49 when the adapter 30 is connected. FIG. 4 also shows an external thread 21 which cooperates with the internal thread of the swivel nut 33 of the adapter 30.

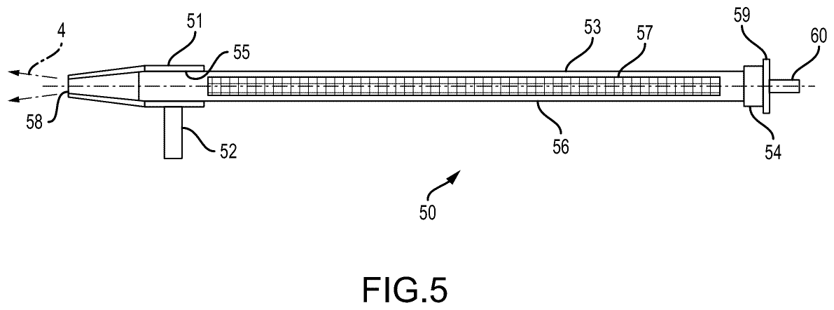

FIG. 5 shows an embodiment of the spray mixer 50. The spray mixer has an elongated, tubular mixer housing 53 with a valve-side or adapter-side end 54 and a distal end 55. Between the valve-side end 54 and the distal end 55, the mixer housing 53 has a central housing section 56 that serves to receive a mixing element 57. The mixing element 57 is preferably a one-piece injection molded plastic part, and therefore can be manufactured at low cost. The mixing element 57 defines a plurality of sequentially connected and interconnected chambers through which the components 2 and 3 flow. The mixing element preferably has a square cross-section. Accordingly, the central housing section 56 is also provided with a square cross-section.

During their flow through the mixing element 57, the components 2, 3 are intensively mixed. On the distal end 55, the already above mentioned atomization sleeve 51 with the inlet 52 is arranged. The atomization sleeve 51 thereby frames an outlet nozzle 58, from which the mixture of first component 2 and second component 3 emerges. The mixture is atomized by the compressed air 5 of the atomization sleeve 51 and a spray jet 4 of the previously mixed multi-component plastic is formed.

Connecting means 59 are provided at the valve-side end 54 to connect the mixer housing 53 to the adapter 30. The connection means 59 comprise two pins 60 which are suitable for engaging in the pockets 42 of the adapter 30. Thus, when connected, spray mixer 50 and adapter 30 cannot rotate relative to each other. Not shown in FIG. 5 is a bayonet lock cover which sits on the mixer housing 53 and can be pushed onto the valve-side end 54 to connect the spray mixer 50 to the adapter 30. For this purpose, the bayonet lock cover is provided with an undercut which can be engaged with the rear edge 44 of the adapter 30 by a 90° rotation.

### LIST OF REFERENCE SIGNS

1 device
2 first component
3 second component
4 spray jet
5 compressed air
10 dosing valve
11 first valve inlet
12 second valve inlet
13 cylinder unit
14 connection
15 grease nipple
16 mouthpiece
17 valve outlet
18 opening
19 opening
20 divider
21 external thread
30 adapter
31 adapter housing
32 valve connection means
33 swivel nut
34 mixer connection means
35 first adapter inlet
36 second adapter inlet
37 first adapter outlet
38 second adapter outlet
39 cover plate
40 rim, rim sections 40a, 40b, 40c, 40d
41 raised portion
42 pocket
43 recess
44 trailing edge
45 conical segment
46 cylindrical segment
47 internal thread
48 grip rib
49 deepening
50 spray mixer
51 atomization sleeve
52 inlet
53 mixer housing
54 valve-side end/adapter-side end
55 distal end
56 middle section
57 mixing element
58 outlet nozzle

1. A device for applying a multicomponent plastic to a substrate, comprising
a dosing valve which can be controlled by compressed air as pressure medium and has a first valve inlet for a first component of the multicomponent plastic, a second valve inlet for a second component of the multicomponent plastic and a valve outlet,
a static spray mixer comprising a tubular mixer housing extending along a longitudinal axis and having a valve-side end and a distal end, a mixing element disposed within the mixer housing for producing a component mixture, and an atomization sleeve disposed on the distal end of the mixer housing and having an inlet for a pressurized atomizing medium,
wherein the mixer housing and the mixing element are made of plastic and the mixing element is a one-piece element that is inserted into the mixer housing.

2. The device according to claim 1, wherein a cross-section of the mixer housing perpendicular to the longitudinal axis and a cross-section of the mixing element perpendicular to the longitudinal axis are each rectangular.

3. The device according to claim 1, wherein the atomization sleeve is attachable to the distal end of the mixer housing along the longitudinal axis of the mixer housing.

4. The device according to claim 1, wherein a separate adapter is provided between the valve outlet of the dosing valve and the valve-side end of the spray mixer for detachably attaching the spray mixer to the dosing valve.

5. The device according to claim 4, wherein the adapter comprises an adapter housing, valve connection means for releasable attachment to the dosing valve, and mixer connection means for releasable attachment of the spray mixer to the adapter.

6. The device according to claim 5, wherein the valve connection means and/or the mixer connection means are integrally formed on the adapter housing.

7. The device according to claim 6, wherein the adapter housing is made of metal.

8. The device according to claim 5, wherein the adapter housing has a recess for receiving a divider of the dosing valve.

9. The device according to claim 5, wherein the adapter housing defines a rectilinear channel for the first component and a rectilinear channel for the second component.

10. The device according to claim 4, wherein the adapter comprises an adapter housing, valve connection means for releasable attachment to the dosing valve; and mixer connection means for releasable attachment of the spray mixer to the adapter;
wherein the adapter housing has a recess for receiving a divider of the dosing valve.

11. The device according to claim 10, wherein the adapter housing defines a rectilinear channel for the first component and a rectilinear channel for the second component.

12. A device for applying a multicomponent plastic to a substrate, comprising:
a dosing valve controllable by compressed air as a pressure medium and having a first valve inlet for a first component of the multicomponent plastic, a second valve inlet for a second component of the multicomponent plastic and a valve outlet,
a static spray mixer comprising a tubular mixer housing extending along a longitudinal axis and having a valve-side end and a distal end;
a mixing element disposed within the mixer housing for producing a component mixture, wherein the mixer housing and the mixing element are made of plastic and the mixing element is a one-piece element that is inserted into the mixer housing; and
an atomization sleeve disposed on the distal end of the mixer housing and having an inlet for a pressurized atomizing medium, the atomization sleeve being attachable to the distal end of the mixer housing along the longitudinal axis of the mixer housing; and
wherein an adapter is provided between the valve outlet of the dosing valve and the valve-side end of the spray mixer for detachably attaching the spray mixer to the dosing valve, the adapter comprising an adapter housing, valve connection means for releasable attachment to the dosing valve; and mixer connection means for releasable attachment of the spray mixer to the adapter; wherein the valve connection means and the mixer connection means are integrally formed on the adapter housing and the adapter housing has a recess for receiving a divider of the dosing valve.

13. A method of spraying a multicomponent plastic onto a substrate using the device according to claim 1.

14. The method according to claim 10, wherein the multicomponent plastic is a polyurea adhesive that is solvent-free and free of volatile organic components.
